(19) United States
(12) Patent Application Publication
(10) Pub. No.: US 2014/0046471 A1
(43) Pub. Date: Feb. 13, 2014

(54) ROBOTIC SCANNING AND PROCESSING SYSTEMS AND METHOD

(71) Applicant: GLOBE MACHINE MANUFACTURING COMPANY, Tacoma, WA (US)

(72) Inventors: Calvin Demont BAMFORD, Tacoma, WA (US); Ronald Marvin JACOBSEN, Puyallup, WA (US); Michael Walter TART, Seattle, WA (US); Robert A. LAW, Lacey, WA (US)

(73) Assignee: GLOBE MACHINE MANUFACTURING COMPANY, Tacoma, WA (US)

(21) Appl. No.: 13/705,664

(22) Filed: Dec. 5, 2012

Related U.S. Application Data
(60) Provisional application No. 61/682,002, filed on Aug. 10, 2012.

(51) Int. Cl. G05B 19/048

(52) U.S. Cl. CPC G05B 19/048; Y10S 901/44
USPC 700/110; 901/44

(57) ABSTRACT

In a robotic scanning and processing system, at least one work station includes a pair of passing lanes along which workpieces are passable, a pair of scanners each for one of the passing lanes, and a robot arranged between the passing lanes and downstream of the scanners. The robot processes the workpieces, that have been scanned by the scanners, based on respective scan results provided by the scanners. Each of the scanners scans at least one workpiece on the respective passing lane, while the robot is processing another workpiece on the other passing lane based on the respective scan result outputted by the other scanner.

### RELATED APPLICATION(S)

The instant application claims priority from U.S. provisional application No. 61/682,002, filed Aug. 10, 2012 and titled “ROBOTIC SCANNING AND REPAIR SYSTEM,” the entire content of which is incorporated by reference herein.

### BACKGROUND

Quality control is a part of almost every manufacturing process, because products, articles or workpieces are often made with a certain amount of defects. For wood-containing products, such as plywood panels, potential manufacturing defects include holes, splits, dead knots, live knots, roundup/wane, resin pocket/streaks etc. For plywood panels, quality control involves inspecting surfaces of the plywood panels and applying patches or other fixes as appropriate. Such a process is time and/or labor consuming if performed manually.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed. Directions X, Y and Z are included, where appropriate, to indicate relationships among the drawings.

FIG. 1A is a schematic top plan view of a robotic scanning and processing system in accordance with some embodiments.

FIG. 1B is an enlarged view of a portion of the robotic scanning and processing system in FIG. 1A.

FIG. 2 is a schematic elevational view, as seen in the Y direction in FIG. 1A, of a feeding station in accordance with some embodiments.

FIG. 3 is a schematic elevational view, as seen in the X direction in FIG. 1A, of a grading station in accordance with some embodiments.

FIG. 4 is a schematic elevational view, as seen in the Y direction and along arrows A-A in FIG. 1A, of a sorting line in accordance with some embodiments.

FIG. 5 is a schematic elevational view, as seen in the X direction and along arrows B-B in FIG. 1A, of a work station in accordance with some embodiments.

FIG. 6 is a schematic elevational view, as seen in the Y direction and along arrows C-C in FIG. 1A, of a part of a discharge line in accordance with some embodiments.

FIG. 7A is a block diagram of a robotic scanning and processing system in accordance with some embodiments.

FIG. 7B is block diagram of a computer platform in accordance with some embodiments.

### DETAILED DESCRIPTION

It is to be understood that the following disclosure provides many different embodiments or examples, for implementing different features of various embodiments. Specific examples of components and arrangements are described below to simplify the present disclosure. An inventive concept may; however, be embodied in many different forms and should not be construed as being limited to the embodiments set forth herein. It will be apparent; however, that one or more embodiments may be practiced without these specific details. Like reference numerals in the drawings denote like elements.

Some embodiments provide a robotic scanning and processing system having a work station in which a robot is placed between, and shared by, a pair of passing lanes with scanners. The robot alternately processes a workpiece on one of the passing lanes while another workpiece is scanned by the scanner on the other passing lane, for maximal utilization of the work station. Some embodiments provide a carriage arrangement for securely holding and moving workpieces from the scanner to the robot without re-registration of the workpieces, thereby increasing the processing speed of the system. Some embodiments provide various scanner arrangements for detecting defects on the workpieces to be repaired by the robot, and/or for pre-grading workpieces that do not meet certain grade standards before entering the work station. A robotic scanning and processing method is also provided in some embodiments.

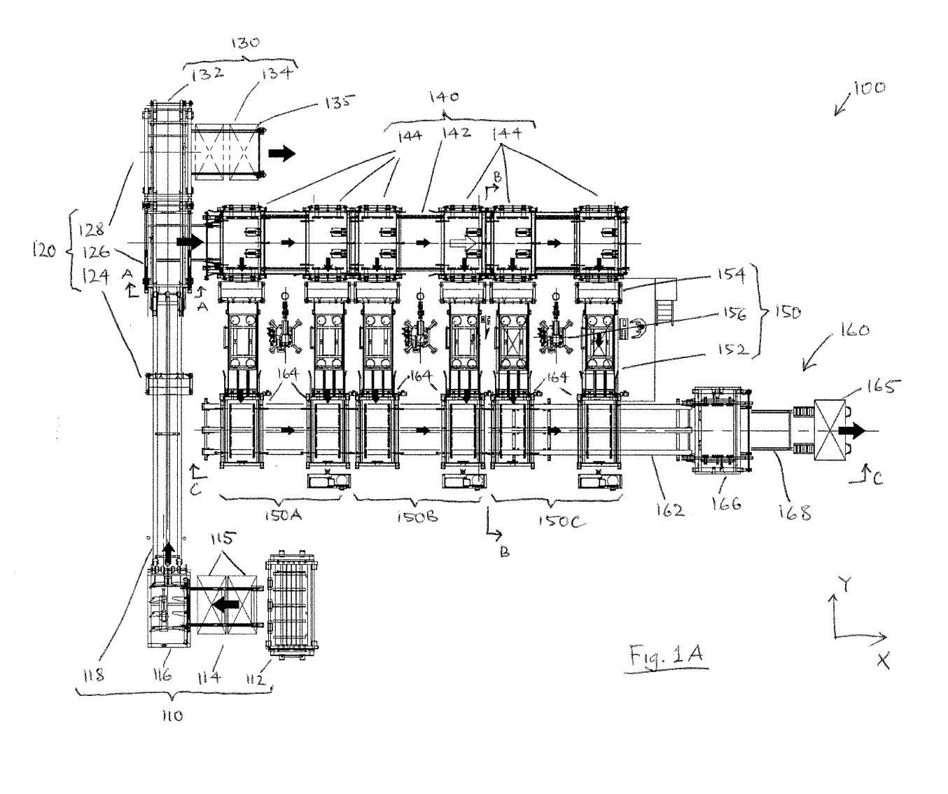

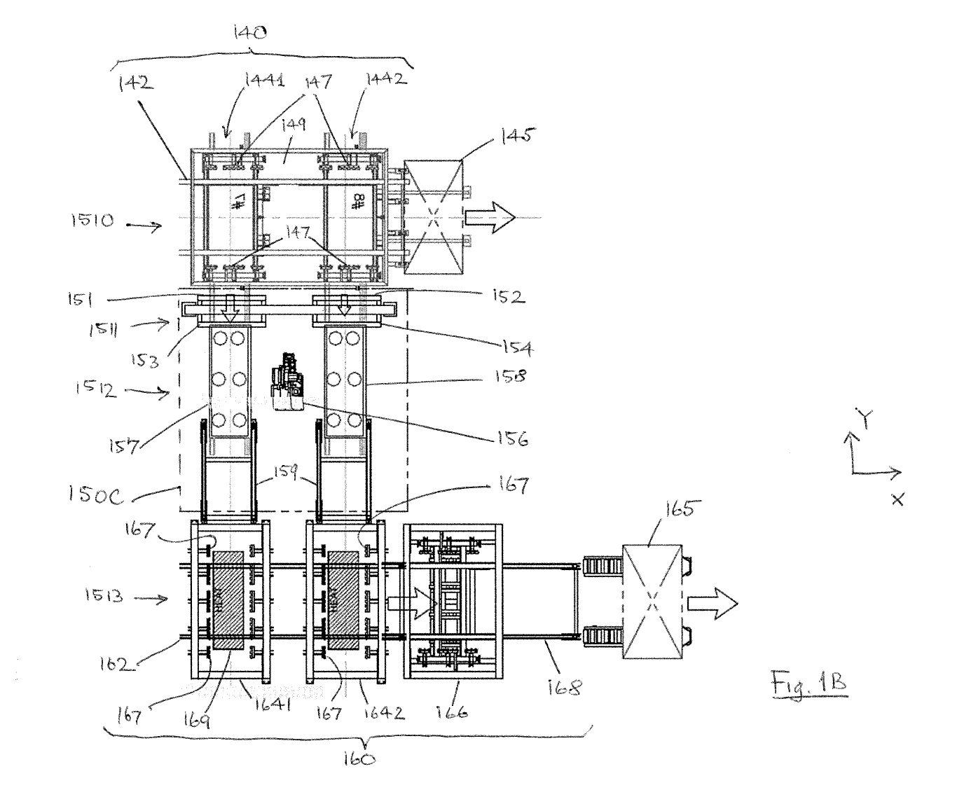

FIG. 1A is a schematic top plan view of a robotic scanning and processing system 100 in accordance with some embodiments. The robotic scanning and processing system 100 includes a feeding station 110, a grading station 120 downstream of the feeding station 110, a reject bin 130 and a sorting line 140 downstream of the grading station 120, at least one work station 150 downstream of the sorting line 140, and a discharge line 160 downstream of the work station 150. In some embodiments, one or more of the feeding station 110, the grading station 120, the reject bin 130, the sorting line 140 and the discharge line 160 is/are omitted and/or replaced by other arrangements.

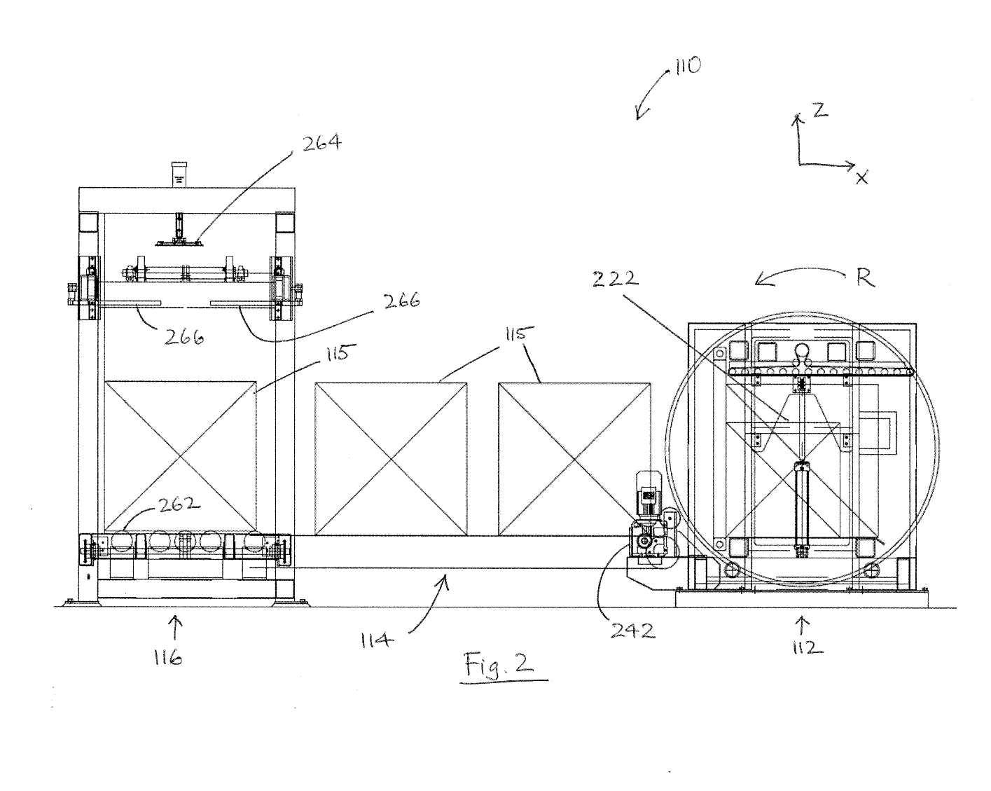

In some embodiments, the feeding station 110 includes a bundle turner 112, a feeder infeed conveyor 114 downstream of the bundle turner 112, a feeder 116 downstream of the feeder infeed conveyor 114, and a feeder outfeed conveyor 118 downstream of the feeder 116. The bundle turner 112 is configured to receive a stack of unprocessed workpieces and then place the stack, which is indicated by a reference numeral 115 in FIG. 1A, on the feeder infeed conveyor 114. The feeder infeed conveyor 114 delivers the stack 115 to the feeder 116. The feeder 116 then raises, one by one, the workpieces in the stack 115 to a predetermined height for delivery by the feeder outfeed conveyor 118 to the subsequent, downstream component of the robotic scanning and processing system 100, e.g., to the grading station 120. In some embodiments, one or more of the bundle turner 112, feeder infeed conveyor 114, feeder 116 and feeder outfeed conveyor 118 is/are omitted and/or replaced by other arrangements. Further details of the feeding station 110 in accordance with some embodiments will be given hereinafter with respect to FIG. 2.

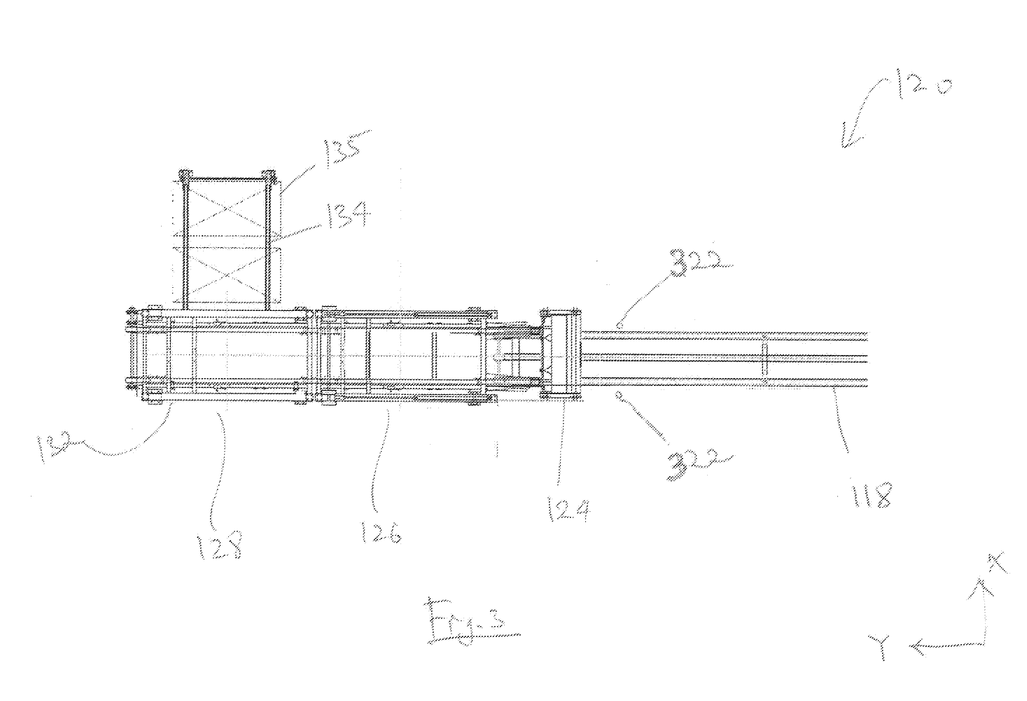

In some embodiments, the grading station 120 includes a grading scanner 124 downstream of the feeder outfeed conveyor 118, and an on-grade drop site 126 and a reject drop site 128 downstream of the grading scanner 124. The grading scanner 124 scans each of the workpieces delivered by the feeder outfeed conveyor 118 to determine whether the workpieces meet a predetermined standard. Workpieces determined by the grading scanner 124 as meeting the predetermined standard, i.e., graded workpieces, are delivered to the subsequent, downstream component of the robotic scanning and processing system 100, e.g., to the sorting line 140, via the on-grade drop site 126. Workpieces determined by the grading scanner 124 as failing to meet the predetermined standard, i.e., rejected workpieces, are delivered to the reject bin 130 via the reject drop site 128. In some embodiments, one or more of the grading scanner 124, on-grade drop site 126 and reject drop site 128 is/are omitted and/or replaced by other arrangements. Further details of the grading station 120 in accordance with some embodiments will be given hereinafter with respect to FIG. 3.

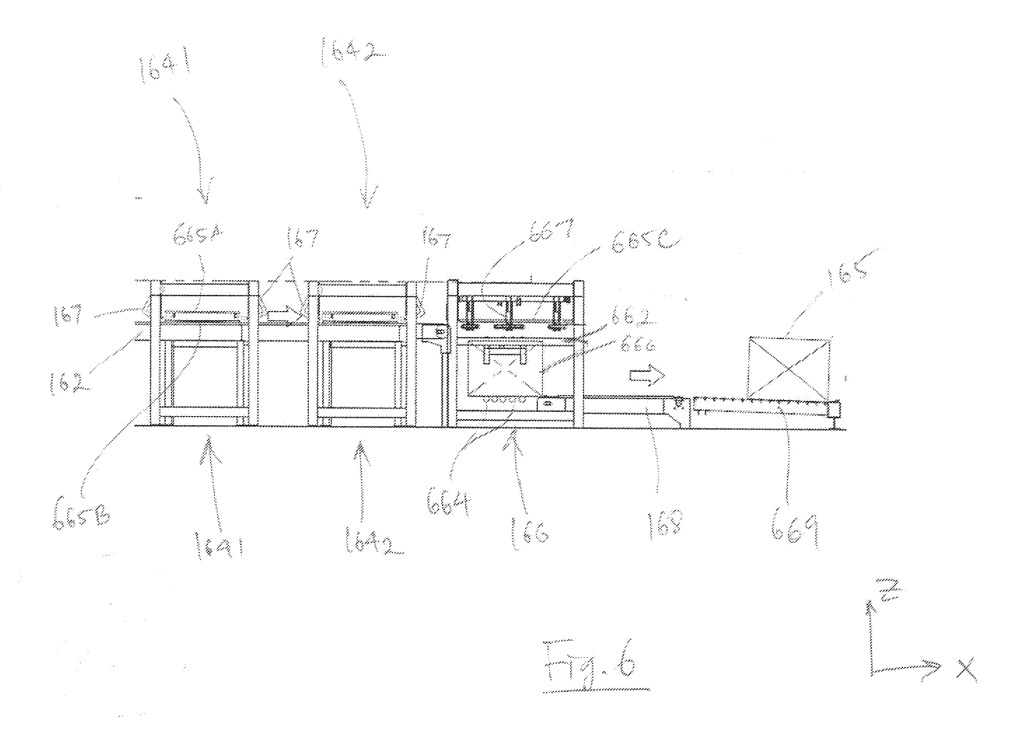

In some embodiments, the reject bin 130 includes a reject stacker 132 disposed under or downstream of the reject drop site 128, and a reject discharge conveyor 134 downstream of the reject stacker 132. The reject stacker 132 receives the rejected workpieces, one by one, and stack the rejected workpieces into a stack 135 of rejected workpieces, which is discharged via the reject discharge conveyor 134. The reject stacker 132 and reject discharge conveyor 134 are similar to the corresponding stacker and discharge conveyor of the discharge line 160 as will be described hereinafter with respect to FIG. 6. In some embodiments, one or more of the reject stacker 132 and reject discharge conveyor 134 is/are omitted and/or replaced by other arrangements.

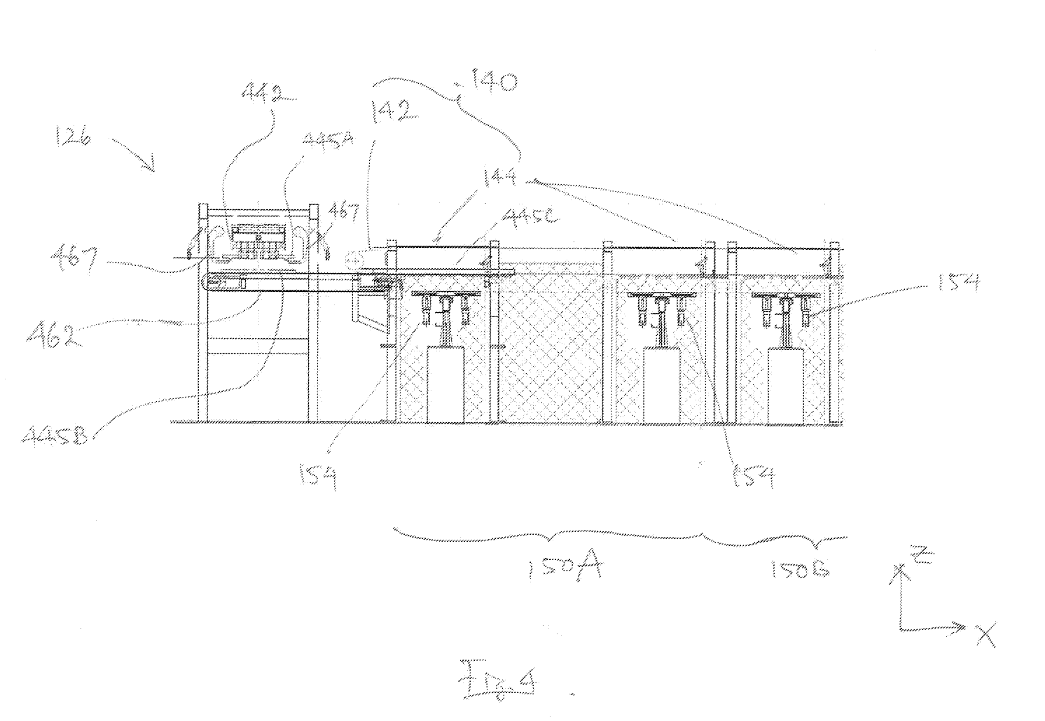

In some embodiments, the sorting line 140 includes a sorting conveyer 142 downstream of the on-grade drop site 126, and a plurality of sorting drop sites 144 arranged along the sorting conveyer 142. The sorting conveyer 142 receives, one by one, the graded workpieces from the on-grade drop site 126 and delivers the workpieces to the sorting drop sites 144 from which the workpieces are delivered to corresponding passing lanes of one or more work stations 150 as will be described herein below. In some embodiments, one or more of the sorting conveyer 142 and sorting drop sites 144 is/are omitted and/or replaced by other arrangements. Further details of the sorting line 140 in accordance with some embodiments will be given hereinafter with respect to FIGS. 1B and 4.

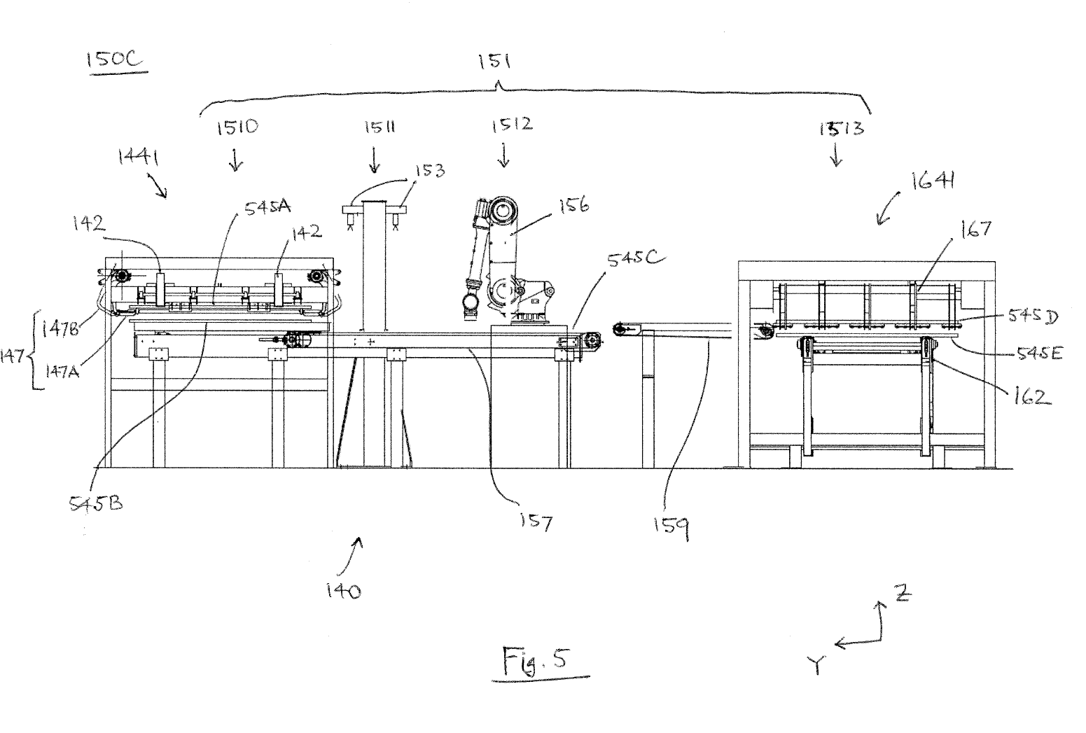

The robotic scanning and processing system 100 includes at least one work station 150. In some embodiments, more than one work stations 150 are included in the robotic scanning and processing system 100. For example, the specific configuration shown in FIG. 1A includes three work stations 150, which are indicated by reference numerals 150A, 150B and 150C and are arranged side by side along the sorting line 140. However, any other number of work stations 150 is contemplated in further embodiments. In some embodiments, each work station 150 includes at least one passing lane 152 equipped with a scanner 154, and a robot 156 arranged along the passing lane 152 and downstream of the scanner 154. The passing lane 152 has a start point disposed under or downstream of a corresponding one of the sorting drop sites 144 for receiving a workpiece therefrom. The received workpiece is passed along the passing lane 152 to a scan position where the scanner 154 scans the workpiece and outputs a respective scan result, in one or more embodiments, directly, to the robot 156. The scanned workpiece is then passed further downstream along the passing lane 152 to a process position where the robot processes the scanned workpiece based on the respective scan result outputted by the scanner 154. The processed workpiece is then delivered to an end point of the passing lane 152 to be discharged via the discharge line 160. Further details of the work station 150 in accordance with some embodiments will be given hereinafter with respect to FIGS. 1B and 5.

In some embodiments, the discharge line 160 includes a cross transfer conveyer 162, a plurality of discharge drop sites 164 arranged along the cross transfer conveyer 162, a stacker 166 downstream of the cross transfer conveyer 162, and a discharge conveyor 168 downstream of the stacker 166. Each of the discharge drop sites 164 is disposed at the end point of the corresponding passing lane 152 of one of the work stations 150. The workpiece that has been processed by the robot 156 in the work station 150 is delivered to the discharge drop site 164 and transferred to the cross transfer conveyer 162. The cross transfer conveyer 162 conveys the processed workpieces received from the work stations 150 via the discharge drop sites 164 to the stacker 166. The stacker 166 receives the processed workpieces, one by one, and stack the processed workpieces into a stack 165 of processed workpieces, which is discharged via the discharge conveyor 168. In some embodiments, one or more of the cross transfer conveyer 162, discharge drop sites 164, stacker 166 and discharge conveyor 168 is/are omitted and/or replaced by other arrangements. Further details of the discharge line 160 in accordance with some embodiments will be given hereinafter with respect to FIGS. 1B and 6.

FIG. 1B is an enlarged view of a portion of the robotic scanning and processing system 100 in FIG. 1A. The enlarged portion of the robotic scanning and processing system 100 in FIG. 1B includes the work station 150C and the corresponding parts of the sorting line 140 and discharge line 160. The other work stations 150A and 150B and the corresponding parts of the sorting line 140 and discharge line 160 are similarly configured and will not be described in detail herein. The work station 150C includes a pair of passing lanes 151, 152 along which workpieces are passable. The work station 150C further includes a pair of scanners 153, 154 each configured to scan the workpieces on one of the passing lanes 151, 152 and to output respective scan results to the robot 156. The robot 156 is arranged between, and shared by, the passing lanes 151, 152 and downstream of the scanners 153, 154. The robot 156 is configured to process the workpieces, that have been scanned by the scanners 153, 154, based on the respective scan results provided by the scanners 153, 154. In some embodiments, a controller (described hereinafter) is coupled to the scanners 153, 154 and the robot 156 to control each of the scanners 153, 154 to scan at least one workpiece on the respective passing lane 151 or 152, while the robot 156 is processing another workpiece on the other passing lane 152 or 151 based on the respective scan result outputted by the other scanner 154 or 153. As a result, maximal utilization of the processing capability of the work station 150 is achievable in one or more embodiments.

Each of the passing lanes 151, 152, e.g., the passing lane 151, has a start point 1510 where a workpiece is delivered from the sorting line 140 to the passing lane 151, a scan position 1511 where the corresponding scanner 153 scans the received workpiece, a process position 1512 where the robot 156 processes the scanned workpiece, and an end point 1513 where the processed workpiece is discharged to the discharge line 160. In some embodiments, each passing lane 151, 152, is provided with a carriage, e.g., a vacuum table 157, 158, which is moveable along the corresponding passing lane 151, 152 from the start point 1510 to the scan position 1511, then to the process position 1512. The vacuum table 157, 158 firmly holds the workpiece thereon as the workpiece and the vacuum table 157, 158 moves from the scan position 1511 to the process position 1512. Therefore, it is possible in at least one embodiment to achieve precise positioning of the scanned workpiece in the process position 1512, such that the respective scan result (including but not limited to, location, size and thickness of the workpiece as well as location and type of defects) outputted by the scanner 153, 154 is directly usable by the robot 156 for processing the workpiece, without re-registration of the workpiece. As a result, the processing speed is increased while processing accuracy and quality are ensured. Although vacuum tables are used in some embodiments as the carriage for moving workpieces along the passing lanes from the scan positions to the process positions, other configurations of such a carriage are used in further embodiments.

The sorting line 140 is configured to feed workpieces to the start points 1510 of the passing lanes 151, 152 via the sorting conveyer 142 and the sorting drop sites 144. Specifically, for each of the passing lanes 151, 152, a sorting drop site, e.g., 1441, 1442, is provided along the sorting conveyer 142 and corresponding to the start point 1510 of the passing lane 151, 152. Each sorting drop site 1441, 1442 is configured to drop the conveyed workpieces, one by one, onto the corresponding vacuum table 157, 158 at the start point 1510 of the corresponding passing lane 151, 152. Workpieces are delivered by the sorting line 140 to the passing lanes 151, 152 that is available for workpiece handling. For example, while the robot 156 is processing a workpiece on the vacuum table 158 on the passing lane 152, the passing lane 151 is available for handling another workpiece. Thus, the vacuum table 157 on the passing lane 151 is moved to the start point 1510 of the passing lane 151. A unprocessed workpiece is delivered by the sorting conveyer 142 along the sorting line 140 to the sorting drop site 1441 corresponding to the start point 1510 of the passing lane 151 where is unprocessed workpiece is dropped onto the vacuum table 157 which firmly holds and moves the unprocessed workpiece to the scan position 1511 to be scanned by the corresponding scanner 153. When no passing lanes are available, the sorting line 140 holds the workpieces over one or more of the sorting drop sites 1441, 1442, ready to be dropped onto the corresponding vacuum tables 157, 158 when the corresponding passing lanes 151, 152 become available for workpiece handling. In at least one embodiment, the robotic scanning and processing system 100 looks ahead, based on the progresses of scanning and/or processing operations in the work stations 150, to estimate the passing lane that will become available next and instruct the sorting line 140 to deliver a unprocessed workpiece to the sorting drop site 144 corresponding to the start point of that passing lane. Other arrangements for workpiece delivery to the passing lanes are used in some embodiments.

In some embodiments, each sorting drop site 1441, 1442 includes a plurality of swing arms 147 (best seen in FIG. 5) pivotable between (a) a first position (best seen at 147A in FIG. 5) where the swing arms 147 support a workpiece from below and (b) a second position (best seen at 147B in FIG. 5) where the swing arms 147 do not support the workpiece from below and cause the workpiece to drop under gravity onto the corresponding vacuum table 157, 158 which has been moved to the start point 1510 of the corresponding passing lane 151, 152. Workpieces are conveyed along the sorting line 140 by the sorting conveyer 142 which, in at least one embodiment, is an overhead conveyor configured to contact each workpiece being conveyed from above (best seen in FIG. 5). Each workpiece is conveyed to the intended sorting drop site 1441, 1442 in a state where the workpiece is sandwiched (best seen at 545A in FIG. 5) between the sorting conveyor 142 from above, and the swing arms 147 from below. As the workpiece conveyed by the sorting conveyer 142 reaches the intended sorting drop site 1441, 1442, a stop plate (not shown) with air cushion is activated to prevent the workpiece from proceeding further, and the swing arms 147 at the intended sorting drop site 1441, 1442 are swung out (e.g., by air-cylinders) from under the workpiece and cause the workpiece to drop (best seen at 545B in FIG. 5) to the vacuum table 157, 158 below. In at least one embodiment, supports such as sliding rails, or rollers etc. are arranged in the spacing 149 between successive sorting drop sites 1441, 1442 to support, from below, the workpiece travelling between the sorting drop sites 1441, 1442.

The discharge line 160 is configured to output workpieces, that have been processed by the robot 156, from end points 1513 of the passing lanes 151, 152, via the discharge drop sites 164 and the cross transfer conveyer 162. Specifically, for each of the passing lanes 151, 152, a discharge drop site 1641, 1642 is provided along the cross transfer conveyer 162 and corresponding to the end point 1513 of the passing lane 151, 152. Each discharge drop site 1641, 1642 is configured to drop the processed workpieces, one by one, onto the cross transfer conveyer 162 which delivers the dropped processed workpieces to the stacker 166. In at least one embodiment, the processed workpieces are transferred from the vacuum tables 157, 158 at the process positions 1512 to the end points 1513 in the corresponding passing lanes 151, 152 by output conveyors 159, such as belt conveyors. In one or more embodiments, the cross transfer conveyer 162 runs continuously to deliver the processed workpieces dropped thereon to the stacker 166. In one or more embodiments, the cross transfer conveyer 162 runs when a processed workpiece is dropped thereon. Other arrangements for workpiece delivery from the passing lanes are used in some embodiments.

In some embodiments, each discharge drop site 1641, 1642 includes a plurality of swing arms 167 (also shown in FIG. 6) similar to the swing arms 147 of the sorting drop site 1441, 1442. Specifically, the swing arms 167 are pivotable between (a) a first position where the swing arms 167 support a processed workpiece from below and (b) a second position where the swing arms 167 do not support the processed workpiece from below and cause the processed workpiece to drop under gravity onto the cross transfer conveyer 162. Each processed workpiece is moved by the corresponding output conveyor 159 into the corresponding discharge drop sites 1641, 1642 in which the processed workpiece is supported from below by the swing arms 167. When the processed workpiece reaches a predetermined position (e.g., above the cross transfer conveyer 162 as best seen at 665A in FIG. 6) in the discharge drop site 1641, 1642, the workpiece is prevented from proceeding further by a back wall of the discharge drop site 1641, 1642 and/or by activating a stop plate (not shown) with air cushion, and the swing arms 167 are swung out from under the processed workpiece and cause the processed workpiece to drop (as best seen at 665B in FIG. 5) onto the cross transfer conveyer 162 below.

In one or more embodiments, each discharge drop site 1641, 1642 further includes a heater 169 for heating the processed workpiece to cure one or more materials in or applied onto the workpiece during the processing by the robot 156. In at least one embodiment, the processed workpiece is not immediately dropped onto the cross transfer conveyer 162 when it reaches the predetermined position at the discharge drop site 1641, 1642. Rather, the processed workpiece is kept at the discharge drop site 1641, 1642 over a predetermined heating or curing period, e.g., 60 seconds, so as to be heated/cured by the corresponding heater 169. At the end of the heating or curing period, the cured workpiece is dropped onto the cross transfer conveyer 162. In at least one embodiment, while the processed workpiece is being heated/cured at the discharge drop site 1641, 1642, the other components in the corresponding passing lanes 151, 152, i.e., the scanners 153, 154 and/or the robot 156, continue to scan and/or process another workpiece. Thus, the curing process does not slow down the flow rate (or processing speed) of the robotic scanning and processing system 100.

FIG. 2 is a schematic elevational view, as seen in the Y direction in FIG. 1A, of the feeding station 110 in accordance with some embodiments. As discussed above, the feeding station 110 includes the bundle turner 112, feeder infeed conveyor 114, feeder 116 and feeder outfeed conveyor 118.

In some embodiments, the bundle turner 112 is an Edge for Edge, barrel-type Stack Turner. Other configurations of the bundle turner 112 are used in further embodiments. A stack of unprocessed workpieces, e.g., un-trimmed plywood, is placed, e.g., by a lift truck, into the bundle turner 112 from the right hand side in FIG. 2. One or more clamp bars 222 of the bundle turner 112 are lowered to clamp the stack under pressure. A directional and sequence valve (not shown) ensures that the stack is not to be rotated until sufficient clamp pressure is achieved. When sufficient clamp pressure is achieved, the bundle turner 112 is rotated about 180 degrees as shown by the arrow R. The clamp of the bundle turner 112 is released, and the stack 115 of unprocessed workpieces is transported out by a powered roll conveyor in the bottom of the bundle turner 112 to the feeder infeed conveyor 114.

In some embodiments, the feeder infeed conveyor 114 is a powered chain conveyor. The chain conveyor includes multiple chain strands sliding on replaceable wear strips in tracks welded to structural steel tubing. The strands are powered by a common drive shaft connection to a gear-reduced electric motor 242. Other configurations of the feeder infeed conveyor 114 are used in further embodiments. The feeder infeed conveyor 114 delivers the stack 115 of unprocessed workpieces to the feeder 116.

In some embodiments, the feeder 116 includes a hoist 262 and a vacuum assembly 264. The hoist 262 has a hoist platform constructed of a welded, tubular steel frame, and is raised and lowered by a hydraulic cylinder, and chain-leveled. The vacuum assembly 264 is supported on a dual slide track with replaceable UHMW (ultra-high-molecular-weight polyethylene) wear strips. The pulling motion of the vacuum assembly 264 is by a hydraulic motor. A vacuum cup of the vacuum assembly 264 is supported and actuated vertically by a pneumatic cylinder. Other configurations of the hoist 262 and/or the vacuum assembly 264 are used in further embodiments. When the stack 115 is conveyed fully onto the hoist platform of the hoist 262 initially at the bottom of the feeder 116, a signal from a controller (described hereinafter) activates the cylinder, raising the stack 115 to a feeding position at a predetermined height. In at least one embodiment, while in the feeding-mode, the hoist 262 maintains a consistent top-of-stack elevation close to the feeding position where the workpieces are lifted, one by one, from the top of the stack 115 by the vacuum assembly 264 into a set of powered pinch rolls (not shown) which pull the workpieces, one by one, from the feeder 116 and onto the feeder outfeed conveyor 118.

In at least one embodiment, the feeder 116 operates continuously, without pausing to receive the next stack. When a stack nears depletion, accumulator paddles 266 are inserted between the hoist platform and the stack. While the accumulator paddles 266 continue to index the stack upward, the hoist platform lowers to the base of the feeder 116 for the next stack. The hoist 262, with the new stack in place, then elevates to a position beneath the accumulator paddles 266, which rotate out and place any remaining workpieces of the current stack on top of the new stack on the hoist 262.

In some embodiments, the feeder outfeed conveyor 118 is a powered belt conveyor. The belt conveyor includes multiple rough-top belt strands, sliding on rectangular steel tubing, powered by a common drive shaft connection to a gear-reduced electric motor. Guards covering drive areas are provided, and are bolted for easy access during setup and maintenance. Other configurations of the feeder outfeed conveyor 118 are used in further embodiments.

In one or more embodiments, the workpieces are cleaned at the feeding station 110, e.g., as the workpieces are conveyed along the feeder outfeed conveyor 118. For example, at least one blower is provided above the feeder outfeed conveyor 118 for blowing dust and/or other contaminants off the surfaces of the workpieces transferred below.

FIG. 3 is a schematic elevational view, as seen in the X direction in FIG. 1A, of the grading station 120 in accordance with some embodiments. The grading station 120 includes a warp detector 322, and, as discussed above, the grading scanner 124, on-grade drop site 126 and reject drop site 128.

In some embodiments, the warp detector 322 includes several sensors (two are illustrated in FIG. 3) mounted to the framework of the feeder outfeed conveyor 118. The sensors of the warp detector 322 detect the high and low points of the workpiece passing by to determine a distance or warp span (or thickness of the workpiece) between the high and low points. If the warp span is greater than a predetermined threshold, the workpiece is rejected. For example, for a plywood panel having a nominal thickness between 0.25 and 1.25 inches, a warp span of 4 inches or more is considered a reject. Other configurations of the warp detector 322 are used in further embodiments. In some embodiments, the warp detector 322 is omitted and/or replaced by other arrangements.

In some embodiments, the grading scanner 124 includes a 2D (two-dimensional) scanner for defect recognition to determine whether the workpieces meet a predetermined standard. For plywood, applicable standards recognizable by the grading scanner 124 include, but are not limited to, APA—The Engineered Wood Association PS1-09 standard; TECO PS 1 or PS 2 standards. An example of a defect that results in a reject is the detection of surface defect areas in a plywood panel. In one or more embodiments, the grading scanner 124 includes at least one camera, at least one light source, a controller and a database with web-based reporting capability. The at least one light source illuminates the surface of the workpiece with one or more light beams which are reflected off the surface and captured as image data by the at least one camera. The captured image data is analyzed by the controller and compared against the database. Based on the comparison, a determination is made as to whether the workpiece meets the predetermined standard or not, and then the workpiece is rejected via the reject bin 130 or proceeds to the sorting line 140 based in the determination. The determination is optionally reported to a controller and/or an operator of the robotic scanning and processing system 100. Other configurations of the grading scanner 124 are used in further embodiments.

As discussed above, workpieces that meet the certain standard proceed to the sorting line 140 via the on-grade drop site 126 which will be described in detail hereinafter with respect to FIG. 4. On the other hand, rejected workpieces are discharged via the reject drop site 128 to the reject bin 130 which includes the reject stacker 132 and the reject discharge conveyor 134. In some embodiments, the reject drop site 128 is configured and operates similarly to the sorting drop sites 144, such as the sorting drop sites 1441, 1442 described with respect to FIG. 1B. More particularly, rejected workpieces are conveyed into the reject drop site 128 by means of a powered overhead belt conveyor contacting the rejected workpieces from above, and by swing arms supporting the rejected workpieces from below. When a rejected workpiece reaches a back stop in the reject drop site 128, a signal from a controller activates the air-cylinders of the swing arms which swing out from beneath the rejected workpieces, thereby dropping the rejected workpieces onto the reject stacker 132 below. Other configurations of the reject drop site 128 are used in further embodiments.

FIG. 4 is a schematic elevational view, as seen in the Y direction and along arrows A-A in FIG. 1A, of the sorting line 140 in accordance with some embodiments. The on-grade drop site 126 of the grading station 120 is also illustrated in FIG. 4. In some embodiments, the on-grade drop site 126 is configured and operates similarly to the sorting drop sites 144, such as the sorting drop sites 1441, 1442 described with respect to FIG. 1B. More particularly, on-grade workpieces are conveyed into the on-grade drop site 126 by means of a powered overhead belt conveyor 442 contacting the workpieces from above, and by swing arms 467 supporting the workpieces from below. When a workpiece reaches a predetermined position (e.g., above a belt conveyor 462 as indicated by reference numeral 445A) in the on-grade drop site 126, the workpiece is prevented from proceeding further by activating a stop plate (not shown) with air cushion, and the swing arms 467 are swung out from under the workpiece and cause the workpiece to drop (as indicated by reference numeral 445B) onto the belt conveyor 462 below. The workpiece is then transferred between the belt conveyor 462 and the sorting conveyer 142 into the sorting line 140 as indicated by reference numeral 445C. Other configurations of the on-grade drop site 126 are used in further embodiments.

Workpieces are subsequently conveyed along the sorting line 140 and sorted into available passing lanes 151, 152 of the work stations 150 as described with respect to FIGS. 1A-1B.

FIG. 5 is a schematic elevational view, as seen in the X direction and along arrows B-B in FIG. 1A, of a passing lane of a work station, in accordance with some embodiments. Specifically, FIG. 5 is a schematic elevational view of the passing lane 151 of the work station 150C described with respect to FIG. 1B. The sorting drop site 1441 and the discharge drop site 1641 corresponding to the passing lane 151 are also illustrated in FIG. 4. As described with respect to FIG. 1B, the vacuum table 157 is moved to the start point 1510 of the passing lane 151 under the sorting drop site 1441. A workpiece delivered along the sorting line 140 to the sorting drop site 1441 (as indicated by reference numeral 545A) is dropped (as indicated by reference numeral 545B) onto the vacuum table 157 when the swing arms 147 swing out from under the workpiece. The vacuum table 157 firmly holds the dropped workpiece thereon, and moves with the firmly held workpiece to the scan position 1511 and then to the process position 1512 for scanning by the scanner 153 and processing by the robot 156 (as indicated by reference numeral 545C). The processed workpiece is conveyed by the output conveyor 159 to the discharge drop site 1641 (as indicated by reference numeral 545D) at the end point 1513 of the passing lane 151 where the processed workpiece is dropped (as indicated by reference numeral 545E) onto the cross transfer conveyer 162 when the swing arms 167 swing out from under the processed workpiece.

In some embodiments, the vacuum table 157 is a driven by timing belt connection to an electric motor, and a high pressure vacuum system with multiple vacuum cups is used to secure the workpiece to the vacuum table 157 for scanning and processing. In at least one embodiment, the vacuum table 157 is driven by an AC Servo drive for accurate control of movement. Other configurations of the vacuum table 157 and/or other types of carriage arrangement are used in further embodiments.

In some embodiments, the scanner 153 includes at least one 3D (three dimensional) scanner or a combination of at least one 3D scanner and at least one 2D scanner. The scanner 153 operates similarly to the grading scanner 124, however, with higher accuracy. In at least one embodiment, two cameras are used to continuously scan workpieces to visual and surface grade specifications using high resolution line scan visual imaging and 3D laser profiling. The scan results are transmitted directly to the robot 156 for processing the workpiece. For plywood panels, the scan results create route and fill patterns for one or more defects, such as holes, splits, dead knots, live knots, roundup/wane, resin pocket/streaks etc. These results are transmitted directly, e.g., via a direct ethernet connection, to the robot 156 as optimized paths for routing and filling the scanned plywood panels. Other configurations of the scanner 153 are used in further embodiments.

The robot 156 uses the scan results outputted by the scanner 153 to process the scanned workpiece. For a plywood panel, the robot 156 repairing defects on the surface of the plywood panel by filling or patching the defects (such as, holes, splits, dead knots, live knots, roundup/wane, resin pocket/streaks etc.) at the locations identified by the scanner 153. An example, non-limiting patching process includes cleaning the defect spot, filling a curable compound in the cleaned defect spot, allowing or forcing (e.g., by heating) the curable compound to cure, sanding the surface of the plywood panel after curing the curable compound, and applying a coating over the surface. In at least one embodiment, the coating is cured when the plywood panel has been moved out of the operational range of the robot 156, e.g., in the corresponding discharge drop site 1641 as described with respect to FIG. 1B. Examples of curable compounds and/or coatings include, but are not limited to, various UV curable polymers.

The robot 156 is equipped with various tools for performing the patching process. For example, in at least one embodiment, the robot 156 includes at least one articulated robot arm with a robot controller that is programmable and has network capability. The robot arm carries, or is connectable in replacement manner to, one or more of a sander for sanding operations, a pressurized air nozzle and/or a vacuum hole for cleaning operations, one or more compound/coating dispensing heads for filing and coating operations, a heater (e.g., a UV heater) for compound curing operations, etc. In at least one embodiment, one or more of the listed tools and/or additional tools are moved and/or controlled by separate servos, rather than by the robot arm. The robot arm is moveable in multiple translational and/or rotational axes by respective servos under control of the robot controller. The patching process described above is for example only, and other processes performable by the robot 156 on workpieces are included in some embodiments. The robot 156 is configured to process other types of wood containing panels in at least one embodiment. The robot 156 is further configured to process non-wood containing panels, such as plastic and/or metal panels, in at least one embodiment. Workpieces with shapes other than planar or panel shapes are also contemplated in further embodiments.

After the processing by the robot 156 at the process position 1512, vacuum is released from the vacuum table 157 and the processed workpiece is moved off the vacuum table 157 toward the end point 1513 by the output conveyor 159. In some embodiments, the output conveyor 159 is a powered lug chain conveyor. When the processed workpiece is clear of the vacuum table 157, idling wheel strands support the workpiece as the lugs drive the workpiece into the discharge drop site 1641. In at least one embodiment, a retractable panel guide assembly mounted on either side of the chain strands, as well as the two point contact of the lugs, keep the workpiece square throughout the repair and/or discharge movement of the workpiece. Other configurations of the output conveyor 159 are used in further embodiments.

FIG. 6 is a schematic elevational view, as seen in the Y direction and along arrows C-C in FIG. 1A, of a part of the discharge line 160 in accordance with some embodiments. As described with respect to FIG. 1B, a processed workpiece arrives at the discharge drop site 1641, 1642 (as indicated by reference numeral 665A) is dropped (as indicated by reference numeral 665B) onto the cross transfer conveyer 162 when the swing arms 167 swing out from under the workpiece. The workpiece is conveyed by the cross transfer conveyer 162 to the stacker 166 (as indicated by reference numeral 665C) where the workpiece is placed on top of a stack 666 of processed workpieces. The stack 666, when full, is outputted as the stack 165 by the discharge conveyor 168.

In some embodiments, the cross transfer conveyer 162 is a powered belt conveyor similar to the feeder outfeed conveyor 118. Other configurations of the cross transfer conveyer 162 are used in further embodiments.

The stacker 166 (and the similarly configured reject stacker 132) includes a plurality of swing arms 667 which operate similarly to the swing arms 167 at the discharge drop sites 1641. Specifically, when a processed workpiece is moved by the cross transfer conveyer 162 into the top part of the stacker 166 (as indicated by reference numeral 665C), the processed workpiece is prevented from proceeding further by a back wall of the stacker 166 and/or by activating a stop plate (not shown) with air cushion, and the swing arms 667 are swung out from under the processed workpiece and cause the processed workpiece to drop on top of the stack 666 below.

In some embodiments, the stacker 166 is a continuous stacker with swing arms 667 driven by air cylinders. The stacker further includes air-cylinder-powered tampers that square the dropped workpiece on top of the stack 666. The stacker 166 also has an elevating hoist platform 662. In at least one embodiment, while in the stacking mode, the hoist platform 662 maintains a consistent top-of-stack elevation with the top of the stack 666 close to the pass line of the cross transfer conveyer 162. When a full stack 666 has been accumulated, the hoist platform 662 drops to the bottom of the stacker 166 for depositing the full stack 666 onto the discharge conveyor 168. The stack 666 is driven from the stacker 166 by powered rolls 664 onto the discharge conveyor 168. Once the stack 165 has been conveyed clear of the hoist platform 662, the hoist platform 662 returns to the elevated position to accept processed workpieces for the next stack. The hoist platform 662 is constructed similar to the hoist platform 262 of the feeder 116.

The stacker 166 operates continuously, without pausing to discharge a full stack, in a manner similar to the feeder 116. Specifically, while the hoist platform 662 is lowered to discharge a full stack 165, a swing-arm type accumulator (not shown) accepts the processed workpieces dropped from the cross transfer conveyer 162 to form a new stack. When the hoist platform 662 is elevated back again and ready to accept additional workpieces, the accumulator assembly withdraws, dropping the accumulated workpieces of the new stack onto the hoist platform 662. The accumulator is actuated by cylinders, and has anti-friction shoe bearings for long service and easy replacement. Other configurations of the stacker 166 are used in further embodiments.

In some embodiments, the discharge conveyor 168 (and the similarly configured reject discharge conveyor 134) is a powered chain conveyor constructed similarly to the feeder infeed conveyor 114. Other configurations of the discharge conveyor 168 are used in further embodiments.

In some embodiments, the discharge line 160 further includes a stack discharge conveyor 669 which includes idling rolls mounted on a sloped structural steel framework. Other configurations of the stack discharge conveyor 669 are used in further embodiments.

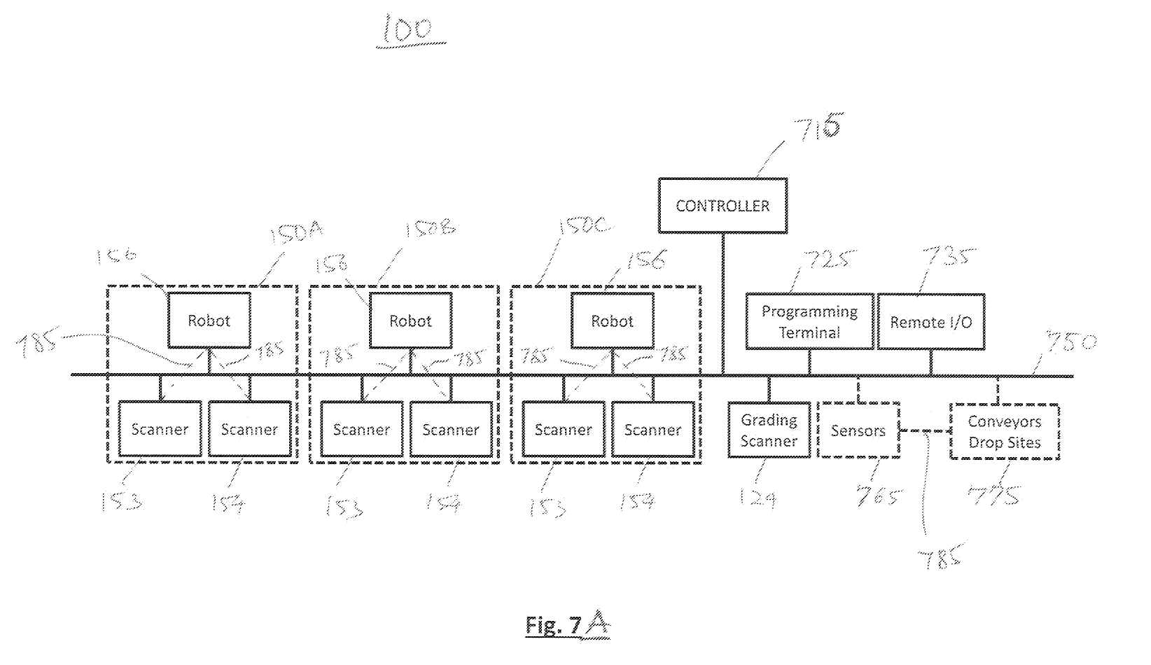

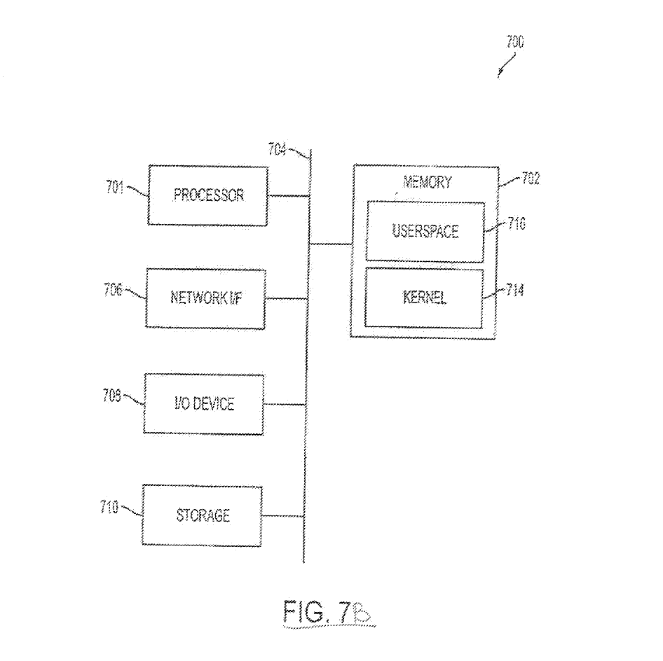

FIG. 7A is a block diagram of the robotic scanning and processing system 100 in accordance with some embodiments. In addition to the work stations 150A-150C with the respective robots 156 and scanners 153, 154 as well as the grading scanner 124 and/or the warp detector 322 (not shown in FIG. 7A), the robotic scanning and processing system 100 further includes a controller 715, a programming terminal 725, a remote input/output (I/O) 735 and a network 750 connecting the above listed components with each other. In at least one embodiment, various sensors 765 and/or the conveyors and drop sites described herein (commonly indicated by reference numeral 775) are also coupled to the network 750. In at least one embodiment, in addition to or in lieu of the network 750, one or more direct connections 785 are provided among various components of the robotic scanning and processing system 100. In some embodiments, one or more of the listed components is/are omitted and/or replaced by other arrangements.

The controller 715 is configured to control various operations of the robotic scanning and processing system 100 as described herein. For example, the controller 715 controls the sorting line 140 to deliver a workpiece to an available passing lane 151, 152 of an available work station 150. In another example, the controller 715 controls one or more of the conveyors and drop sites 775 to hold, deliver, discharge, reject or drop workpieces as the workpiece handling operation progresses. In yet another example, the controller 715 controls the speed (flow rate) at which workpieces are progressed through the robotic scanning and processing system 100. In a further example, the controller 715 controls one or more other components not specifically described herein, such as valves, pumps, motors, servos, etc. The control of the controller 715 is based, in at least one embodiment, on data provided by the sensors 765 and/or feedback from the components being controlled, such as the robots 156, scanners 153, 154, 124 etc. In at least one embodiment, the controller 715 is a centralized controller that controls all or most of the components in the robotic scanning and processing system 100. In at least one embodiment, functions of the controller 715 are performed by various controllers distributed in the robotic scanning and processing system 100. Other configurations of the controller 715 are used in further embodiments.

The programming terminal 725 is a control console, such as a computer, which provides an interface for an operator to interact with, program, or monitor operation statuses of various components of the robotic scanning and processing system 100. In at least one embodiment, the programming terminal 725 permits the operator to override control by the controller 715 and to control one or more components directly. Other configurations of the programming terminal 725 are used in further embodiments.

The remote I/O 735, such as an Internet gateway or a router, permits a remote operator to control, monitor, trouble-shoot or make adjustments to various operation parameters of the robotic scanning and processing system 100. Other configurations of the remote I/O 735 are used in further embodiments.

The network 750, such as an ethernet network, provides two way communication among various components of the robotic scanning and processing system 100. In at least one embodiment, more than one networks 750 are provided for redundancy and/or for signal separation, e.g., data is transmitted over one network whereas control signals and commands are transmitted over another network. Other types of network, such as wireless or near-field networks, are used in some embodiments.

FIG. 7B is block diagram of a computer platform 700 in accordance with some embodiments. The computer platform 700 is applicable to the controller 715, the programming terminal 725, and/or other controllers distributed in the robotic scanning and processing system 100. The computer platform 700 comprises a processor 701, a memory 702, a network interface (I/F) 706, a storage 710, an input/output (I/O) device 708 communicatively coupled via a bus 704 or other interconnection communication mechanism.

The memory 702 comprises, in some embodiments, a random access memory (RAM) and/or other dynamic storage device and/or read only memory (ROM) and/or other static storage device, coupled to the bus 704 for storing data and/or instructions to be executed by the processor 701, e.g., kernel 714, userspace 716, portions of the kernel and/or the userspace, and components thereof. The memory 702 is also used, in some embodiments, for storing temporary variables or other intermediate information during execution of instructions to be executed by the processor 701.

In some embodiments, a storage device 710, such as a magnetic disk or optical disk, is coupled to the bus 704 for storing data and/or instructions, e.g., kernel 714, userspace 716, etc. The I/O device 708 comprises an input device, an output device and/or a combined input/output device for enabling user interaction with the computer platform 700. An input device comprises, for example, a keyboard, keypad, mouse, trackball, trackpad, and/or cursor direction keys for communicating information and commands to the processor 701. An output device comprises, for example, a display, a printer, a voice synthesizer, etc. for communicating information to a user.

In some embodiments, one or more operations and/or functionality described with respect to FIGS. 1-6 are realized by the processor 701, which is programmed for performing such operations and/or functionality. One or more of the memory 702, the I/F 706, the storage 710, the I/O device 708, the hardware components 718, and the bus 704 is/are operable to receive instructions, data and/or other parameters for processing by the processor 701.

In some embodiments, one or more of the operations and/or functionality described with respect to FIGS. 1-6 is/are implemented by specifically configured hardware (e.g., by one or more application specific integrated circuits (ASICs) which is/are included) separate from or in lieu of the processor 701. Some embodiments incorporate more than one of the described operations and/or functionality in a single ASIC.

In some embodiments, the operations and/or functionality are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

The above description includes example operations, which are not necessarily required to be performed in the order shown and/or described. Operations may be added, replaced, changed order, and/or eliminated as appropriate, in accordance with the spirit and scope of embodiments of the disclosure. Embodiments that combine different features and/or different embodiments are within the scope of the disclosure and will be apparent to those of ordinary skill in the art after reviewing this disclosure.

According to some embodiments, a robotic scanning and processing system, comprises at least one work station and a controller. The work station includes a pair of passing lanes along which workpieces are passable, a pair of scanners, and a robot arranged between the passing lanes and downstream of the scanners. Each scanner is configured to scan the workpieces on one of the passing lanes and to output respective scan results. The robot is configured to process the workpieces, that have been scanned by the scanners, based on the respective scan results provided by the scanners. Each of the scanners is configured to scan at least one workpiece on the respective passing lane, while the robot is processing another workpiece on the other passing lane based on the respective scan result outputted by the other scanner.

According to some embodiments, a robotic scanning and processing system comprises at least one work station and a sorting line. The work station includes at least one passing lane along which workpieces are passable, at least one scanner, and a robot downstream of the scanner. The scanner is configured to scan the workpieces on the passing lane and to output respective scan results. The robot is configured to process the workpieces, that have been scanned by the scanner, based on the respective scan results provided by the scanner. The sorting line is configured to feed workpieces to a start point of the passing lane. The sorting line comprises a first conveyor configured to convey workpieces along the sorting line to the start point, and a first drop site configured to drop the conveyed workpieces, one by one, under gravity onto the start point of the passing lane. The passing lane comprises a table movable between (i) the start point of the passing lane where the table is arranged to receive the workpiece dropped from the first drop site and (ii) a process position of the passing lane where the robot is arranged to process the workpiece on the table, via (iii) a scan position of the passing lane where the scanner is arranged to scan the workpiece on the table. The table is configured to hold the workpiece thereon during a movement of the table from the start point to the scan position and then to the process position, without re-registration of the workpiece between the scan position where the workpiece is to be scanned by the respective scanner and the process position where the workpiece is to be processed by the robot.

According to some embodiments, in a robotic scanning and processing method, a plurality of panels is fed along a sorting line over start points of a pair of passing lanes of a work station. The work station further comprises a pair of scanners each for one of the passing lanes and a robot arranged between the passing lanes and downstream of the scanners. Each of the passing lanes comprises a moveable table. The panels fed along the sorting line are dropped, one by one, onto the start points of the passing lanes. Each of the dropped panels is received on the corresponding table at the corresponding start point. The table is moved, while holding the received panel thereon, along the corresponding passing lane. The panel moved along the passing lane is scanned with the corresponding scanner which outputs a respective scan result to the robot. The scanned panel is processed with the robot based on the respective scan result. The panel is moved by the table from the scanning operation to the processing operation without re-registration of the panel. The processing operation is performed for the scanned panel on one of the passing lanes while the scanning operation is being performed for another panel on the other passing lane.

It will be readily seen by one of ordinary skill in the art that one or more of the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A robotic scanning and processing system, comprising:
at least one work station comprising:
a pair of passing lanes along which workpieces are passable;
a pair of scanners each configured to scan the workpieces on one of the passing lanes and to output respective scan results; and
a robot arranged between the passing lanes and downstream of the scanners, the robot configured to process the workpieces, that have been scanned by the scanners, based on the respective scan results provided by the scanners;
wherein each of the scanners is configured to scan at least one workpiece on the respective passing lane, while the robot is processing another workpiece on the other passing lane based on the respective scan result outputted by the other scanner.

2. The robotic scanning and processing system of claim 1, comprising a plurality of said work stations arranged side by side.

3. The robotic scanning and processing system of claim 1, wherein each of the scanners comprises a 3D scanner.

4. The robotic scanning and processing system of claim 3, wherein each of the scanners further comprises a 2D scanner.

5. The robotic scanning and processing system of claim 1, wherein each of the scanners is configured to directly transmit the scan result corresponding to a workpiece to be processed by the robot to the robot.

6. The robotic scanning and processing system of claim 1, further comprising:
a sorting line configured to feed workpieces to start points of the passing lanes, wherein the sorting line comprises
a first conveyor configured to convey workpieces along the sorting line through the start points; and
for each of the passing lanes, a first drop site configured to drop the conveyed workpieces onto the start point of the passing lane.

7. The robotic scanning and processing system of claim 6, wherein each of the passing lanes comprises a carriage movable between (i) the start point of the passing lane where the carriage is arranged to receive the workpiece dropped from the corresponding first drop site and (ii) a process position of the passing lane where the robot is arranged to process the workpiece on the carriage, via (iii) a scan position of the passing lane where the respective scanner is arranged to scan the workpiece on the carriage.

8. The robotic scanning and processing system of claim 7, wherein the carriage is a vacuum table configured to hold the workpiece thereon during a movement of the vacuum table from the start point to the scan position and then to the process position, without re-registration of the workpiece between the scan position where the workpiece is to be scanned by the respective scanner and the process position where the workpiece is to be processed by the robot.

9. The robotic scanning and processing system of claim 6, further comprising:
a discharge line configured to output workpieces, that have been processed by the robot, from end points of the passing lanes, wherein the discharge line comprises
a second conveyor configured to convey the processed workpieces along the discharge line through the end points; and
for each of the passing lanes, a second drop site configured to drop the processed workpieces from the end point of the passing lane onto the second conveyor.

10. The robotic scanning and processing system of claim 9, further comprising:
a grading station configured to feed workpieces to the sorting line, wherein the grading station comprises
at least one of a further scanner or detector configured to determine whether the workpieces meet a predetermined standard;
a third drop site downstream of the at least one of further scanner or detector and configured to drop the workpieces that meet the predetermined standard onto the sorting line; and
a fourth drop site downstream of the at least one of further scanner or detector and configured to reject the workpieces that do not meet the predetermined standard; and
a third conveyor configured to convey the workpieces through the at least one of further scanner or detector, the third drop site and the fourth drop site.

11. The robotic scanning and processing system of claim 10, wherein the further scanner comprises a 2D scanner and the detector comprises a warp detector.

12. The robotic scanning and processing system of claim 10, wherein at least one of the first through fourth drop sites comprises a plurality of swing arms pivotable between (a) a first position where the swing arms are arranged to support a workpiece from below and (b) a second position where the swing arms are not arranged to support the workpiece and cause the workpiece to drop under gravity.

13. The robotic scanning and processing system of claim 12, wherein at least one of the first through third conveyors corresponding to the at least one drop site with the swing arms comprises an overhead conveyor configured to contact each workpiece being conveyed from above and to convey the workpiece to the at least one drop site with the swing arms in a state where the workpiece is sandwiched between the overhead conveyor and the swing arms.

14. The robotic scanning and processing system of claim 13, wherein the at least one drop site with the swing arms is further configured to stop the workpiece, with an air cushion, before or simultaneously with a pivoting movement of the swing arms from the first position to the second position for dropping the workpiece under gravity.

15. The robotic scanning and processing system of claim 10, further comprising:
a feeder configured to receive a stack of unprocessed workpieces and to raise the unprocessed workpieces, one by one, to a predetermined height from which the workpieces are arranged to be sequentially dropped under gravity onto the sorting line, the passing lanes and the discharge line; and
a stacker configured to receive the processed workpieces, one by one, from the second conveyor of the discharge line, and to stack the processed workpieces into a stack of processed workpieces.

16. A robotic scanning and processing system, comprising:
at least one work station comprising:
at least one passing lane along which workpieces are passable;
at least one scanner configured to scan the workpieces on the passing lane and to output respective scan results; and
a robot downstream of the scanner, the robot configured to process the workpieces, that have been scanned by the scanner, based on the respective scan results provided by the scanner; and
a sorting line configured to feed workpieces to a start point of the passing lane, wherein the sorting line comprises
a first conveyor configured to convey workpieces along the sorting line to the start point; and
a first drop site configured to drop the conveyed workpieces, one by one, under gravity onto the start point of the passing lane;
wherein the passing lane comprises a carriage movable between (i) the start point of the passing lane where the carriage is arranged to receive the workpiece dropped from the first drop site and (ii) a process position of the passing lane where the robot is arranged to process the workpiece on the carriage, via (iii) a scan position of the passing lane where the scanner is arranged to scan the workpiece on the carriage; and
wherein the carriage is configured to hold the workpiece thereon during a movement of the carriage from the start point to the scan position and then to the process position, without re-registration of the workpiece between the scan position where the workpiece is to be scanned by the respective scanner and the process position where the workpiece is to be processed by the robot.

17. The robotic scanning and processing system of claim 16, further comprising:
a discharge line configured to output workpieces, that have been processed by the robot, from an end point of the passing lane, wherein the discharge line comprises
a second conveyor configured to convey the processed workpieces along the discharge line away from the end point; and
a second drop site configured to drop the processed workpieces, one by one, from the end point of the passing lane onto the second conveyor.

18. The robotic scanning and processing system of claim 17, wherein
at least one of the first and second drop sites comprises a plurality of swing arms pivotable between (a) a first position where the swing arms are arranged to support a workpiece from below and (b) a second position where the swing arms are not arranged to support the workpiece and cause the workpiece to drop under gravity; and
at least one of the first and second conveyors corresponding to the at least one drop site with the swing arms comprises an overhead conveyor configured to contact each workpiece being conveyed from above and to convey the workpiece to the at least one drop site with the swing arms in a state where the workpiece is sandwiched between the overhead conveyor and the swing arms for dropping the workpiece under gravity in response to a pivoting movement of the swing arms from the first position to the second position.

19. A robotic scanning and processing method, comprising:
feeding a plurality of panels along a sorting line over start points of a pair of passing lanes of a work station, the work station further comprising a pair of scanners each for one of the passing lanes and a robot arranged between the passing lanes and downstream of the scanners, each of the passing lanes comprising a moveable carriage;
dropping, one by one, the panels fed along the sorting line onto the start points of the passing lanes;
receiving each of the dropped panels on the corresponding carriage at the corresponding start point;
moving the carriage, while holding the received panel thereon, along the corresponding passing lane;
scanning the panel moved along the passing lane with the corresponding scanner which outputs a respective scan result to the robot; and
processing the scanned panel with the robot based on the respective scan result,
wherein
the panel is moved by the carriage from said scanning to said processing without re-registration of the panel, and
said processing is performed for the scanned panel on one of the passing lanes while said scanning is being performed for another panel on the other passing lane.

20. The robotic scanning and processing method of claim 19, further comprising pre-scanning panels to determine whether the panels meet a predetermined standard;
dropping, one by one, the panels that have been determined by the pre-scanning as meeting the predetermined standard onto the sorting line; and
dropping, one by one, the panels that have been determined by the pre-scanning as failing to meet the predetermined standard into a reject bin.
